(19) United States
(12) Patent Application Publication
(10) Pub. No.: US 2025/0199336 A1
(43) Pub. Date: Jun. 19, 2025

(54) IMPROVEMENTS IN OR RELATING TO ADJUSTABLE FOCAL LENGTH LENSES AND APPARATUS INCORPORATING THE SAME

(71) Applicant: ADLENS LIMITED, Eynsham (GB)

(72) Inventors: Robert Edward STEVENS, Eynsham (GB); Thomas Norman Llyn JACOBY, Eynsham (GB); Graeme MACKENZIE, Eynsham (GB)

(73) Assignee: ADLENS LIMITED, Eynsham (GB)

(21) Appl. No.: 18/856,454

(22) PCT Filed: Apr. 6, 2023
(86) PCT No.: PCT/GB2023/050920

§ 371 Date: Oct. 11, 2024

(30) Foreign Application Priority Data
Apr. 14, 2022 (GB) 2205610.5
May 11, 2022 (GB) 2206907.4

(51) Int. Cl. G02C 7/08

(52) U.S. Cl. CPC G02C 7/081

(57) ABSTRACT

An ophthalmic apparatus comprising at least two corrective lenses (5, 5′) that are mounted to a support (113) for supporting the lenses in front of a user's eyes (1, 1′), thereby defining a viewing direction through each lens (5, 5′); at least one of the lenses being a variable focal length lens comprising front (131) and rear (141) superposed lens elements having cooperating optical surfaces that are shaped such that the focal length of the variable focal length lens is variable according to the relative lateral disposition (d) of the front (131) and rear (141) lens elements to provide a power, where d=0 is defined as the relative position of the front (131) and rear (141) lens elements at which the variable focal length lens provides an overall horizontal meridional power Φp corresponding to the intended user's prescription, and where the front lens element (131) has a fixed power Φr and a rear lens element (141) has a fixed power Φr, such that: ΦP=Φf+Φr+Φ° A wherein O° A is the power provided by the variable focal length lens at d=0, and wherein Φr has the same sign as Φp, is equal to between about 5% and about 80% of Φp.

The present disclosure relates to adjustable focal length optical lenses. More particularly, the present disclosure relates to improved Alvarez-type adjustable focal length lenses, and ophthalmic apparatus incorporating the same.

### BACKGROUND TO THE INVENTION

WO2021/069930 A1, the contents of which are incorporated herein by reference, discloses the glasses 11 of kind shown in FIGS. 1 and 2. The glasses 11 comprise two variable focal length lenses 21, 22 mounted in a frame 12. The variable focal length lenses 21, 22 are of the kind that consist of two solid, optically clear lens elements that are arranged one in front of the other in the direction of viewing through the lens (indicated by axis z in FIG. 2 for each of the lenses 21, 22) and are slidable relative to one another in a direction transverse the direction of viewing (indicated by axis x in FIG. 2) for varying the focal length of the lens. The lenses 21, 22 are mounted in the frame 12 such that the transverse axis x of sliding of the lens elements 31, 41 is oriented substantially horizontally relative to a user in normal use, as shown in FIG. 2.

Variable focal length lenses of this kind are well known in the art and are often referred to generically as Alvarez lenses or Lohmann lenses. Alvarez lenses are disclosed in U.S. Pat. No. 3,305,294 A, the contents of which is incorporated herein by reference. Other adjustable lenses with cubic and higher order surfaces are disclosed by U.S. Pat. Nos. 3,583,790 A, 7,338,159 B2, 7,717,552 B2, 5,644,374 A, and WO 2013/030603 A1, the contents of all of which are also incorporated herein by reference. In general, an adjustable lens of this kind comprises two superposed lens elements, each having opposite front and rear optical surfaces that are configured to control the thickness of each lens element between the surfaces, such that when rays of light pass through both lens elements in succession, the lens causes them to converge or diverge in a manner equivalent to a spherical lens. The thickness of each of lens elements varies according to a cubic function in an x, y-plane that is perpendicular to the direction of viewing through the lens and in a manner that is complementary to the other lens element, such that the nearest equivalent spherical optical power (NES) of the lens varies according to the relative lateral disposition of the lens elements.

A suitable equation for defining the thickness t of each lens element between its opposite front and rear surfaces is:

$$t = A ( \frac{{x}^{3}}{3} + {xy}^{2} ) + Dx + E \qquad ( 1 )$$

wherein D is a constant representing the coefficient of a prism removed to minimise lens thickness and may be zero; E is a constant representing lens element thickness at the optical axis z of the lens; x and y represent coordinates on a rectangular coordinate system centred on the optical axis and lying in a plane perpendicular thereto; and A is a constant representing the rate of lens power variation with relative lens element movement in the x direction, being positive for one of the lens elements and negative for the other lens element. However, as mentioned above, numerous variations on, and extensions to this formula are known in the art, and the present invention is not limited in this respect.

As those skilled in the art will appreciate, a single lens element of an Alvarez lens does not have an optical axis as such, but a pair of lens elements acts like a normal spherical lens, so for any given relative position of the lens elements it is possible to define the optical axis as the position that correlates with the centre of the effective spherical lens, i.e. where there is no angular deflection of a ray passing through the lens. In equation (1) above, the “optical axis” is the origin of the equation which may conveniently be used to define the z-axis for aligning the lens in optical programs and the like, but subject to the other surfaces, it might not necessarily correspond to the effective optical axis of the overall lens. Indeed, in the case where one element is static, and the other is moving, the optical axis will also move to close to the centre position between the two cubic surface origins.

Conveniently, one surface of each lens element may be flat or formed with a regular surface of revolution, e.g. spherical, while the opposite surface has a cubic surface of the kind described above to control the thickness of the lens element. The cubic surface of each lens element may suitably, in some embodiments, be formed on an (a) spherical base curve in a manner known in the art. The lens elements may thus be arranged to slide relative to one another along a line or along a defined path, for example an arc having a component on the z-axis. For instance, in some cases, the lens elements may be arranged to slide relative to one another on an arc in the horizontal (x,z) plane relative to a user. In the examples that follow, the cubic surfaces have been arranged on adjacent inner surfaces of the front and rear lens elements, rather than on the corresponding outer surfaces. This preferred arrangement reduces aberrations from off-axis viewing.

In the glasses of WO2021/069930 A1, the two lenses 21, 22 are similar in terms of their construction, so for convenience only the left-hand lens 21 (as viewed from the perspective of a user) is described below for reference, but the right-hand lens 22 is similar, being a mirror image in the movement of the left-hand lens 21 in medial plane extending in the z-direction intermediate the two lenses 21, 22. The following description of the left-hand lens 21 thus applies equally to the right-hand lens 22. However, it would be perfectly normal for an ametropic wearer to have a different corrective power requirement in each eye.

The variable focal length lens 21 thus comprises a front lens element 31 and a rear lens element 41. The front element 31 has a convex spherical, sphero-cylindrical, multifocal or freeform front surface 32 and a cubic rear surface 33 of the kind described above. The rear lens element 41 has a cubic front surface 42 of the kind described above, which complements the rear surface 33 of the front lens element 31 to form an Alvarez lens, and a concave spherical, sphero-cylindrical, multifocal or freeform rear surface 43.

Typically, the front surface 32 of the front lens element 31 and the rear surface 43 of the rear lens element 41 have the same spherical curvature and do not therefore contribute any net optical power to the lens 21. However, in some cases the front surface of the front lens element 31 and the rear surface 43 of the rear lens element 41 may be mutually configured to cause convergence or divergence of rays of light passing through both elements in the manner of a spherical lens with positive or negative optical power. Thus, the lens 21 may be provided with a fixed prescription according to a user's requirements.

In glasses where a fixed prescription is provided in this manner, it has been observed that the amount of prism Δ exhibited by the variable focal length lens as the optical centre of the lens is moved towards the bridge 14 can cause discomfort to the wearer of the glasses due to excess vergence or divergence stimulation of the eye, as described below with reference to FIGS. 3A and 3B.

FIG. 3A is a partial view of glasses 111 having a variable focal length lens 121 comprising a front element 131 which is fixed to a frame 113 and where a fixed prescription is provided entirely by a movable rear lens element 141. In FIG. 3A the front lens element 131 and rear lens element are shown at a nominal zero relative lateral displacement d. In this configuration, the lens 121 is arranged for distance viewing and provides a total prescription power Pp. As illustrated, where there is no prescribed prism, a ray of light 150 can pass undeflected close to the optical centre of the lens 121 and into the eye 160 of the wearer of the glasses 111.

FIG. 3B shows the same glasses 111 of FIG. 3A, but with the rear lens element 141 having been displaced a lateral distance d relative to the front lens element 131 to provide a focusing power appropriate near viewing, Φp+Φn, where Φn is an additional power resulting from the relative disposition of the lens elements 131, 141. In this case, a light ray 150 emanating from the point at which the wearer of the glasses 111 wishes to focus is deflected by an angle α as it passes through the lens 121, which results in the wearer having to look along an effective line of sight 170 which does not match that which is anticipated by the brain due to the effective accommodation experienced (as a result of Φp+Φn) by the eye 160. This problem, known as excess prism, is well documented as causing discomfort to users of eyewear.

An object of the present invention is to provide ophthalmic apparatus comprising variable focal length lenses which ameliorates one or more of the problems described above.

### SUMMARY OF THE INVENTION

According to a first aspect of the invention, therefore, there is provided an ophthalmic apparatus comprising at least two corrective lenses that are mounted to a support for supporting the lenses in front of a user's eyes, thereby defining a viewing direction through each lens; at least one of the lenses being a variable focal length lens comprising front and rear superposed lens elements having cooperating optical surfaces that are shaped such that the focal length of the variable focal length lens is variable according to the relative lateral disposition d of the front and rear lens elements to provide a power ΦA, where d=0 is defined as the relative position of the front and rear lens elements at which the variable focal length lens provides an overall horizontal meridional power Φp corresponding to the intended user's prescription, and where the front lens element has a fixed power Φ_{f} and a rear lens element has a fixed power Φᵣ, such that:

$${Φ}_{P} = {Φ}_{f} + {Φ}_{r} + {Φ}_{A}^{0}$$

where Φ_{A}⁰ is the power provided by the variable focal length lens at d=0, and wherein Φᵣ has the same sign as Φₚ and is equal to between about 5% and about 80% of Φₚ.

The ophthalmic apparatus according to the invention therefore splits the fixed corrective power of the lenses (i.e. the power contribution that is not due to the relative lateral displacement of the lens elements) between the front and rear lens elements. As described in detail below, the inventors have discovered that such an arrangement may advantageously reduce the amount of prism exhibited by the superposed lens elements as they are laterally displaced with respect to one another.

The ophthalmic apparatus may, for example, comprise a pair of eyeglasses. However, in principle, the ophthalmic apparatus may comprise any binocular viewing apparatus. The other corrective lens may also be variable focal length lens. The other variable focal length lens may be a substantially identical mirror image of the other lens. Such an arrangement may be appropriate, for example, where the ophthalmic apparatus is for use by a wearer having eyes requiring the same corrective prescription. However, the corrective prescription of the two variable focal length lenses may differ if, for example, a wearer has eyes requiring different corrective prescriptions, as is often the case.

It is also within the scope of the present invention to provide a variable focal length lens having any required fixed prescription power. However, in some embodiments the variable focal length lens may be configured to provide a prescription power Φₚ having a magnitude of at least about 2 dioptres. In other embodiments the variable focal length lens may be configured to provide a prescription power Φₚ having a magnitude of at least about 3 dioptres.

The variable focal length lens may be configured such that the fixed power of the second lens element, Φᵣ, meets the following criterion:

$${Φ}_{r} = \frac{Δ}{100 d} + \frac{( {Φ}_{p} - {Φ}_{A}^{0} ) ( {vp}_{d} k ) - {kd}_{max} ( 1 - {vp}_{d} k )}{2}$$

where dₘₐₓ is the maximum relative lateral disposition of the front and rear lens elements, k is the rate of power addition provided by the front and rear lens elements as the lens elements are laterally displaced with respect to one another, p_{d} is the interpupillary distance of the user for whom the apparatus is configured, v is the distance between the centre of eyeball rotation and the rear surface of the variable focal length lens. For an adult, p_{d} is typically between about 50 millimetres and about 75 millimetres. v may be between about 10 millimetres and about 30 millimetres. Δ is the total prism measured in dioptres per metre of the variable focal length lens at d=dₘₐₓ. The variable focal length lens may be configured with prism Δ in the range of from about −0.66 to about +0.58.

The variable focal length lens may be configured such that 50<k<500 dioptres per millimetre. In some embodiments the variable focal length lens may be configured such that 150<k<300 dioptres per millimetre.

The variable focal length lens may be configured to operate across a range of relative lateral displacements of the front and rear lens elements of between about 2 and about 8 mm. However, in other embodiments of the invention the variable focal length lens may be configured to operate across smaller or larger ranges of relative lateral displacement.

The variable focal length lens may be configured such that Φᵣ has the same sign as Φₚ and is equal to between about 10% and about 60% of Φₚ. In some embodiments the variable focal length lens may be configured such that Φᵣ has the same sign as Φₚ and is equal to at least about 20% of Φₚ, and preferably at least about 40% of Φₚ.

In some embodiments, the variable focal length lens may comprise a varifocal region. The varifocal region may be configured to provide a power change equal to about 0.5 D or more across at least part of the region. The varifocal region may be a bifocal or trifocal, or other type of multifocal region. The varifocal region may be a progressive addition region. Where the variable focal length lens is provided with a varifocal region, the lens may be configured such that Φᵣ has the same sign as Φₚ and is equal to between about 5% and about 80% of Φₚ at least in region of the lens outside of the varifocal region.

Where the variable focal length lens comprises a varifocal region, the rates of change of inset with add power within the varifocal region for the Alvarez contribution to add power and the progressive addition contribution to add power are within about 1 prism dioptre of each other. The rates of change of inset with add power within the varifocal region for the Alvarez contribution to add power and the progressive addition contribution to add power may be equal to within about 0.5 prism dioptre of each other, and in some embodiments within about 0.25 dioptres of each other.

The front lens element may be fixedly mounted to the support and the rear lens element may be movable relative to the front lens element for varying the relative lateral disposition of the lens elements. In other embodiments it may be that the rear lens element is fixedly mounted to the support and the front lens element is movable relative to the rear lens element. In some embodiments both lens elements may be configured to undergo some degree of movement when varying the relative lateral disposition of the lens elements.

The ophthalmic apparatus may be adjustable focal length eyewear. For example, eyeglasses. The ophthalmic apparatus may form part of an AR, VR, or XR headset.

The apparatus may form part of a visor or other corrective headwear. The apparatus may comprise more than one lens for each eye.

The other corrective lens may be a variable focal length lens comprising any of the features disclosed above with respect to the at least one variable focal length lens. For example, the other corrective lens may be a variable focal length lens having similar properties to the at least one variable focal length lens so that the both corrective lenses provide equal correction to left and right eyes of a wearer of the apparatus. Alternatively, the other corrective lens may be a variable focal length lens having different properties to the at least one variable focal length lens such that the corrective lenses provide different correction to the left and right eyes of a wearer of the apparatus, as required.

According to a second aspect of the invention, there is provided a pair of lens elements suitable for forming the front and rear superposed lens elements of the at least one variable focal length lens according to the first aspect of the invention. The pair of lens elements according to the second aspect of the invention may comprise any of the features of the respective front and rear lens elements according to the first aspect of the invention.

Following is a description by way of example only with reference to the accompanying drawings of embodiments of the present invention.

### BRIEF DESCRIPTION OF THE DRAWINGS

In the drawings:

FIG. 1 is a perspective view from above and to the left-hand side of the front of a pair of glasses comprising two variable focal length lenses mounted to a frame;

FIG. 2 is a perspective view from above and to the left-hand side of the front of the glasses of FIG. 1 showing rear lens elements of the variable focal length lenses detached from cooperating front lens elements;

FIG. 3A is a schematic drawing of an eye gazing through a variable focal length Alvarez lens with the front and rear lens elements having zero relative lateral displacement;

FIG. 3B corresponds to FIG. 3A but where the rear lens element has been displaced a distance d with respect to the front lens element;

FIG. 4A is a schematic top-down drawing of a glasses wearer looking at a near object;

FIG. 4B is an enlarged drawing of left eye and lens shown in FIG. 4A;

FIG. 5 is a plot showing, for an Alvarez lens having a fixed prescription, values of rear lens prescription power Φᵣ which yield acceptable prism for given values of target prescription power Φₚ; and

FIG. 6 plots the results shown in FIG. 5 in terms of Φᵣ/Φₚ.

### DETAILED DESCRIPTION OF THE INVENTION

The inventors have discovered that, for an ophthalmic device comprising an Alvarez-type lens providing a fixed prescription in addition to the variable focal power afforded by relative lateral displacement of the lens elements, the lenses can be made optically more comfortable, lighter, and thinner by distributing the fixed prescription between the lens elements to reduce the amount of prism exhibited by the lens as the lens elements are laterally displaced with respect to one another.

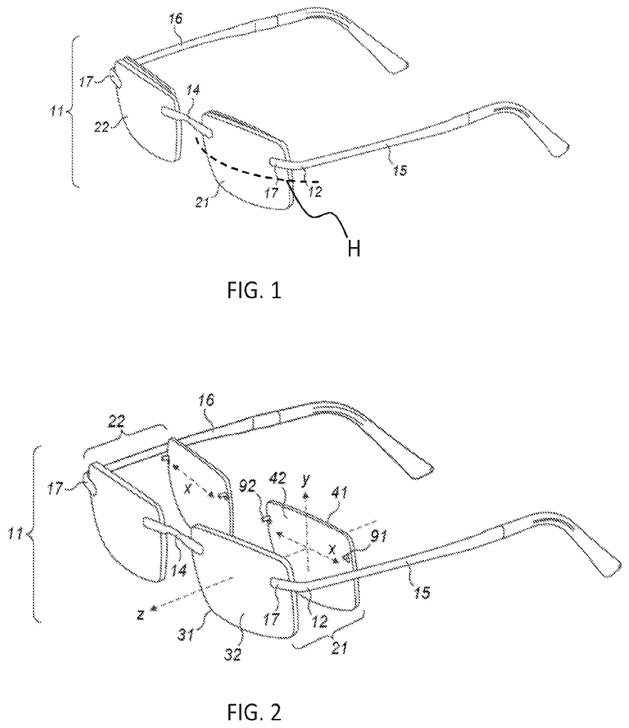

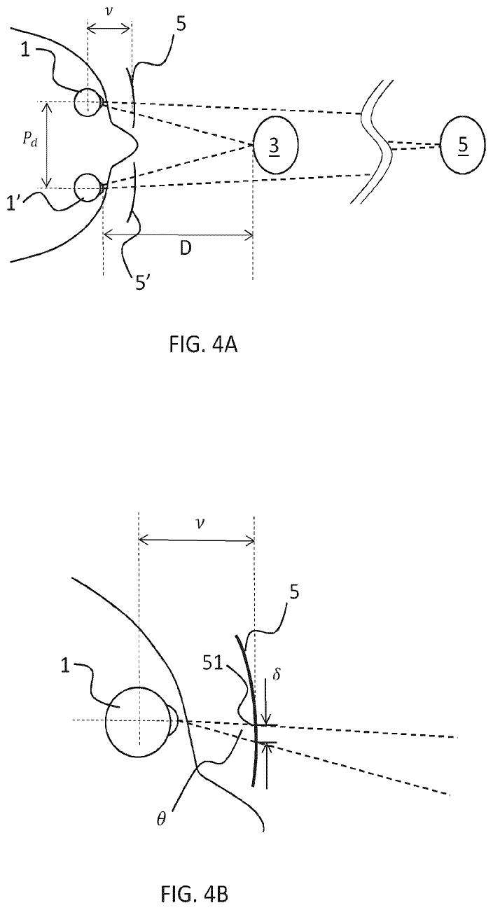

FIG. 4A is a schematic illustration of a pair of eyes 1, 1′ separated by an inter-pupillary distance, p_{d}, viewing an object 3 at a distance, D, through a pair of lenses, 5, 5′ which provide a fixed prescription for distance viewing along a horizontal meridian of the lenses 5, 5′. For illustrative purposes, the horizontal meridian H of the left variable focal length lens 21 of the glasses 11 is shown in FIG. 1. As can be seen, the horizontal meridian is a the line defined by the front and rear lens elements 31, 41 along which the gaze of an eye of a wearer intercepts when gazing from left to right, or vice versa, through the lens 21, with no rotation of the eye causing the gaze angle to shift vertically.

As illustrated in FIG. 4B when viewing the object 3, the eyes must rotate by a gaze angle θ relative to their orientation when viewing an object 5 at distance to verge on the object 3 such that the line of sight through the lenses 5, 5, is inset by a distance δ along the horizontal meridian from a centre 51 of the lens 5, which is where the lens is optically centred for distance viewing.

Where a user requires a positive addition powered lens having a power Φₙ to correct their vision at the near distance D, the inset distance δ, can be approximated as:

$$δ = \frac{{vp}_{d} {Φ}_{n}}{2} \qquad ( 2 )$$

where v is the distance between centre of eyeball rotation and the lens, and where D is taken to be approximately 1/Φₙ. This assumes D»δ. Where, for example, a user requires glasses having a positive addition power Φₙ, that addition power can therefore be provided at an appropriate inset distance δ obtained from equation (2) in order to ensure an appropriate vergence-accommodation ratio and thereby optical comfort for the user. This compensation is known in the art of single-element progressive and bifocal lenses.

It is also known in the art that the expression for δ can be modified for converging or diverging corrective lenses, and the following analysis may be extended with that. However, the following analysis is described for the convergence of the eyes as if corrected without that perturbation, such as when wearing contact lenses.

### Prism in Alvarez Lenses Comprising a Fixed Distance Prescription

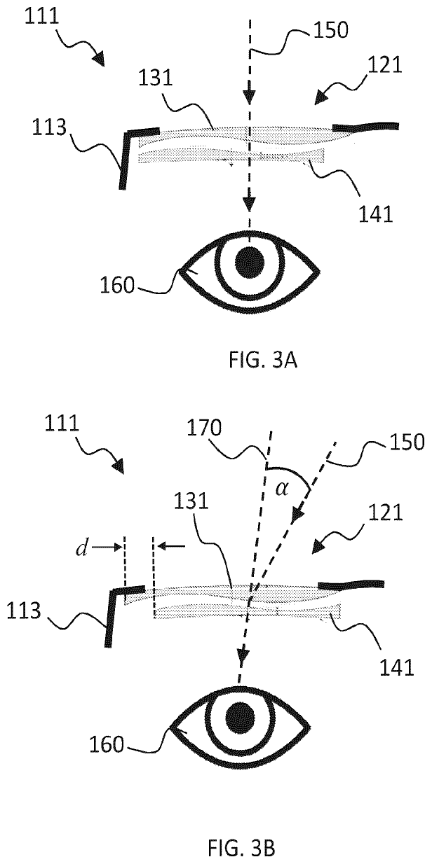

In an Alvarez lens, of the type shown in FIGS. 3A and 3B, the positive addition power, Φₙ, can be provided by the optical surfaces of the lens elements as the lens elements are displaced with respect to one another by a distance d. In this case, for a given relative lateral displacement d, the positive addition power, Φₙ, is given by:

$${Φ}_{n} = {Φ}_{A}^{d} - {Φ}_{A}^{0} = kd \qquad ( 3 )$$

where Φ_{A}^{d} is the total Alvarez addition power at relative lateral displacement d, Φ_{A}⁰ is the total Alvarez addition power when d=0, k is the rate of power addition with relative translation of two Alvarez elements in dioptres per metre (this is closely related to the A-coefficient in equation (1) above). Combining equation (3) with equation (2), it can be shown that, for an Alvarez lens, the inset varies with the relative lateral displacement of the lens elements

$$δ = \frac{{vp}_{d} k}{2} d \qquad ( 4 )$$

For the Alvarez lens pair providing a power addition of Φₙ with a relative lateral displacement of the lens elements d, as described above, and comprising a static front lens element providing prescription power Φ_{f}, and a movable rear lens providing a prescription power Φᵣ, the total prism, Δ, experienced along the line-of-sight of the wearer is equal to the sum of the components of prism provided by the front prescription, the rear prescription, and by the relative lateral displacement d of the lens elements. The total prism, Δ, can be approximated using Prentice's Rule as:

$$Δ = 100 \{ {Φ}_{r} ( d - δ ) + ( {Φ}_{A}^{d} - {Φ}_{A}^{0} ) ( \frac{d}{2} - δ ) + {Φ}_{f} ( - δ ) \} \qquad ( 5 )$$

Noting that the distance prescription horizontal meridional power Φₚ, which is intended to be viewed at zero relative lateral displacement of the lens elements, is given by

$${Φ}_{P} = {Φ}_{f} + {Φ}_{r} + {Φ}_{A}^{0} \qquad ( 6 )$$

and by substituting equations (4) and (6) into equation (5), the prescription power Φᵣ of the rear lens element can be written in terms of the distance prescription horizontal meridional power Φₚ as

$${Φ}_{r} = \frac{Δ}{100 d} + \frac{( {Φ}_{P} - {Φ}_{A}^{0} ) ( {vp}_{d} k ) - kd ( 1 - {vp}_{d} k )}{2} \qquad ( 7 )$$

### Optimising Alvarez Lenses Providing a Fixed Prescription for Minimum Prism

Ideally, the amount of prism Δ provided by a lens should be zero for optimum viewing comfort of the user. Accordingly, for a given distance prescription horizontal meridional power Φₚ, an appropriate prescription power Φᵣ of the rear lens element can be calculated from equation (7) by setting Δ=0:

$${Φ}_{r} = \frac{( {Φ}_{P} - {Φ}_{A}^{0} ) ( {vp}_{d} k ) - kd ( 1 - {vp}_{d} k )}{2} \qquad ( 8 )$$

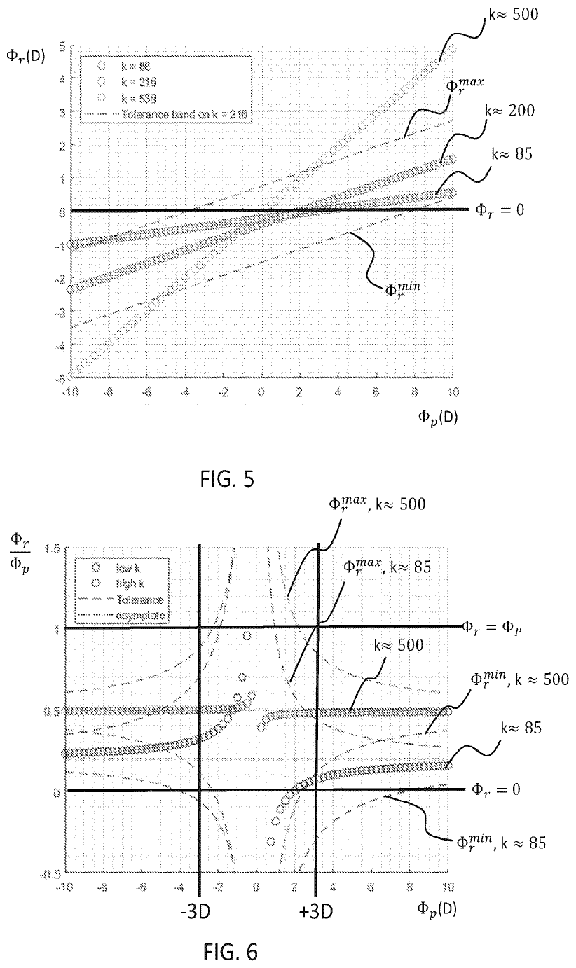

This result is plotted in FIG. 5 for approximate k values of 85, 200, and 500 dioptres per metre, and with d being approximately 6 mm, which is representative of the maximum lateral displacement for which a pair of eyeglasses comprising such lenses might be designed. With these values of k and d, the lenses provide maximal Alvarez additions Φₙ of 0.5 D, 1.25 D and 3 D respectively The plot also uses vales of v and pa which are representative of a typical glasses wearer. It is envisaged that for many types of eyewear using typical materials, such as polycarbonate, k will typically be between 85 and 500 dioptres per metre. With a k value of less than 85, there is very little Alvarez addition and there may be little value in producing such lenses. A k value of 500 dioptres per metre is already in the region where, with typical materials, highly curved Alvarez surfaces are required. Such lenses may be aesthetically unacceptable to the typical wearer, and the achievable relative lateral translation where the curved surfaces face one another may be limited by the curved surfaces impinging on one another.

Furthermore, it is noted that a lens wearer can typically tolerate a certain amount of prism and still find viewing comfortable. The exact limits of prism tolerance are known to be highly individual to the lens wearer. However, some general limits are known in the prior art. For example, Percival's Criterion, where −1.33≤P≤+1.33, P being the prism expressed as a fraction of the maximum sustainable binocular divergence or convergence. For distance viewing various standards exist, such as ISO 21987 and similarly ANSI Z80.1. Using such limits as input values for Δ in equation (7), a range of acceptable values of Φᵣ for a given Φₚ can be determined, as illustrated by the lines of Φᵣ^{min} and Φᵣ^{max} plotted for k≈200 in FIG. 5.

FIG. 5 demonstrates that the inventors' discovery that for many values of Φₚ, the moving rear lens element power Φᵣ should not be equal to zero for the ideal prism balance. Instead, the prescription power Φᵣ of the rear lens element should be determined based upon the distance prescription power Φₚ and other parameters of equation (7). Taking k≈200 as a specific example, it can be seen that for Φₚ<−4, a moving lens element Φᵣ=0 falls outside of the limits of comfort, indicated by the lines of Φᵣ^{min} and Φᵣ^{max} so in this case the fixed prescription should be distributed between the front and rear elements, suitably within the limits prescribed by the lines of Φᵣ^{min} and Φᵣ^{max}.

FIG. 6 plots the results of FIG. 5 in terms of Φᵣ/Φₚ for k=85, and 500, along with lines of Φᵣ^{min}/Φₚ and Φᵣ^{max}/Φₚ, obtained via Percival's criterion at those k values. For values k between 85 and 500, acceptable values of Φᵣ/Φₚ will lie between Φᵣ^{min}/Φₚ for k=85 and Φᵣ^{max}/Φₚ for k=500. While embodiments of the invention may comprise variable focal length lenses with any value of Φₚ required by a user's prescription, as can be seen from FIG. 6, within the band of approximately −3<p<3, the prism constraint is not as limiting and suitable lenses can be provided with Φᵣ=0. However, outside of this range of Φₚ, splitting the fixed prescription of the variable focal length lens between the front and rear lens elements may be particularly advantageous. It is therefore envisaged that embodiments of the invention comprise variable focal length lenses having values of Φₚ with a magnitude of greater than about 3 dioptres.

Additionally, the inventors have discovered that, for Alvarez-type variable focal length lenses which are also provided with a fixed progressive addition power, such as by a bifocal, trifocal, varifocal, or progressive lens, the rates of inset with add power for the Alvarez contribution to add power and the progressive addition contribution to add power should be within a tolerance of one another in order to avoid stimulating vergence-accommodation conflict in the permutations of providing near-vision addition power.

Where a fixed focal length lens (i.e. a lens that has no user-adjustable focal length) comprises a progressive addition power, such as in varifocal lens, the progressive addition will typically be arranged at an inset 8 (for example, determined by equation (2)) to enforce an appropriate vergence-accommodation ratio with increasing add power, and to thereby ensure near distance viewing comfort for a user of the ophthalmic apparatus in which a pair of such lenses are carried.

In some embodiments of the invention, it may be desirable to provide an Alvarez-type variable focal length lens with a progressive addition power. However, the Alvarez lens elements will also have an intrinsic rate of inset with add power determined by equation (8). An Alvarez-type lens having a progressive addition power will therefore unavoidably provide an array of add powers and insets contributed by the relative disposition of the Alvarez lens elements which overlap with the range of add power contributed by the progressive addition power. If the rates of inset with add power for the Alvarez contribution and the progressive addition contribution are not consistent in a given pair of such variable focal length lenses, then a user of an ophthalmic device comprising such variable focal length lenses may be presented with an array of conflicting vergence-accommodation ratios when viewing objects through the lenses at a given focal length but at different relative dispositions of the lenses.

In order to maintain user comfort in an Alvarez-type variable focal length lens with a progressive addition power, the inventors have discovered that the rates of change of inset with add power for the Alvarez contribution and the progressive addition contribution should ideally be configured to be within about 1 prism dioptre of one another. In embodiments of the invention, the rates of inset with add power for the Alvarez contribution and the progressive addition contribution may be configured to within about 0.5 prism dioptre of one another, and in some embodiments within about 0.25 prism dioptre of each other.

Additionally, some embodiments of the invention may be subject to constraints which ensure that the aesthetic qualities of the variable focal length lenses are similar to those of fixed focal length lenses. For example, the curve of the front outer surface of the front lens element should preferably be greater than about +1 D and the curve of the rear surface of the rear lens element should preferably be less than about −0.5 D, in order to mitigate reflections and to have an appearance similar to fixed focal length lenses.

1. Ophthalmic apparatus comprising at least two corrective lenses that are mounted to a support for supporting the lenses in front of a user's eyes, thereby defining a viewing direction through each lens; at least one of the lenses being a variable focal length lens comprising front and rear superposed lens elements having cooperating optical surfaces that are shaped such that the focal length of the variable focal length lens is variable according to the relative lateral disposition d of the front and rear lens elements to provide a power Φ_{A}, where d=0 is defined as the relative position of the front and rear lens elements at which the variable focal length lens provides an overall horizontal meridional power Φₚ corresponding to the intended user's prescription, and where the front lens element has a fixed power Φ_{f} and a rear lens element has a fixed power Φᵣ, such that:
$${Φ}_{P} = {Φ}_{f} + {Φ}_{r} + {Φ}_{A}^{0}$$
where Φ_{A}⁰ is the power provided by the variable focal length lens at d=0; and
wherein Φᵣ has the same sign as Φₚ and is equal to between about 5% and about 80% of Φₚ.

2. Ophthalmic apparatus according to claim 1, wherein the variable focal length lens is configured to provide a prescription power Φₚ of less than about −3 dioptres or more than about +3 dioptres.

3. Ophthalmic apparatus according to claim 1, wherein the variable focal length lens is configured such that the fixed power of the rear lens element, Φᵣ, meets the following criterion:
$${Φ}_{r} = \frac{Δ}{100 d} + \frac{( {Φ}_{p} - {Φ}_{A}^{0} ) ( {vp}_{d} k ) - {kd}_{max} ( 1 - {vp}_{d} k )}{2}$$
where dₘₐₓ is the maximum relative lateral disposition of the front and rear lens elements, k is the rate of power addition provided by the front and rear lens elements as the lens elements are laterally displaced with respect to one another, p_{d} is the interpupillary distance of the user for whom the apparatus is configured, v is the distance between the centre of eyeball rotation and the rear surface of the variable focal length lens, and Δ is the total prism measured in dioptres per metre of the variable focal length lens at d=dₘₐₓ, wherein the variable focal length lens is configured with prism Δ in the range of from about −0.66 to about +0.58.

4. Ophthalmic apparatus according to claim 1, wherein the variable focal length lens is configured such that 50<k<500 dioptres per millimetre.

5. Ophthalmic apparatus according to claim 1, wherein the variable focal length lens is configured to operate across a range of relative lateral displacement of the front and rear lens elements of between about 2 and 8 mm.

6. Ophthalmic apparatus according to claim 1, wherein Φᵣ has the same sign as Φₚ and is equal to between about 10% and about 60% of Φₚ.

7. Ophthalmic apparatus according to claim 1, wherein Φᵣ has the same sign as Φₚ and is equal to at least about 20% of Φₚ, and preferably at least about 40% of Φₚ.

8. Ophthalmic apparatus claim 1, wherein the variable focal length lens comprises a varifocal region configured to provide a power change equal to about 0.5 D across at least part of the region.

9. Ophthalmic apparatus according to claim 8, wherein the varifocal region is a progressive addition region, and wherein Φᵣ has the same sign as Φₚ and is equal to between about 5% and about 80% of Φₚ at least in region of the lens above the progressive addition region.

10. Ophthalmic apparatus according to claim 8, wherein the rates of change of inset with add power within the varifocal region for the Alvarez contribution to add power and for the progressive addition contribution to add power are within about 1 prism dioptre of each other.

11. Ophthalmic apparatus according to claim 1, wherein the front lens element is fixedly mounted to the support and the rear lens element is movable relative to the front lens element for varying the relative lateral disposition of the lens elements.

12. Ophthalmic apparatus according to claim 1, wherein the apparatus is adjustable focal length eyewear.

13. Ophthalmic apparatus according to claim 1, wherein the apparatus is forms part of an AR, VR, or XR headset.

14. Ophthalmic apparatus according to claim 1, wherein the apparatus forms part of a visor or other corrective headwear.

15. A pair of lens elements suitable for forming the front and rear superposed lens elements of the at least one variable focal length lens according to claim 1.
